(19) United States
(12) Patent Application Publication
(10) Pub. No.: US 2015/0058756 A1
(43) Pub. Date: Feb. 26, 2015

(54) System For The Presentation, Creation, Organization, Analysis, And Curation Of Information Through The Use Of A Dynamic, Living, Online Ecosystem Which Can Mutually Interact With The Real World

(71) Applicant: Uriverse, Inc., Palo Alto, CA (US)

(72) Inventor: Ryoul Hee Kwak, Palo Alto, CA (US)

(21) Appl. No.: 14/467,794

(22) Filed: Aug. 25, 2014

Related U.S. Application Data
(60) Provisional application No. 61/869,549, filed on Aug. 23, 2013.

(51) Int. Cl. H04L 29/06; H04L 12/58; G06F 3/0481; H04L 29/08

(52) U.S. Cl. CPC H04L 65/403; H04L 67/10; H04L 51/32; G06F 3/04815
USPC 715/757

(57) ABSTRACT

A social network computer system is provided. The computer system includes a social media server with a computer processor, memory connected to the computer processor for storing information associated with a social media network, for providing said information to the computer processor, and for storing information regarding system users associated with a social network. The social network computer system also includes a social network module programmed to display, to an observer, a representation of a plurality of system users in a node graph wherein each system user is represented by an object in the node graph, and wherein a distance between objects in the node graph indicates strength of relationship between said objects.

### RELATED APPLICATIONS

The present application claims the benefit of U.S. Provisional Application Ser. No. 61/869,549, filed Aug. 23, 2013, which is expressly incorporated herein by reference in its entirety.

### BACKGROUND INFORMATION

1. Field of the Disclosure

The present invention relates to the communication of information on the internet. In particular, examples of the present invention relate to a system for presenting information to users and may provide a social network to the users. The system may present information in a 3-dimensional space which highlights distance and relatedness of information and may provide users with different methods of interacting with the information.

2. Background

The internet has grown to include many online stores, communities, and sources of information. Since the inception of the internet, data has been available in a document style; a flat format. Development of the internet and the webpages used to display information to users has focused on the design or style of the webpage. Increased computational power has allowed for increased amounts on information to be displayed on webpages, and has allowed for more data heavy information such as images and video content to be displayed on webpages. While significant amounts of information have been added to the internet, the manner of presentation of the information has largely remained unchanged.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a computer system in context of a social network system.

FIG. 2 is a schematic illustrating information flow within the system.

FIG. 3 is a schematic illustrating a method of rendering information within the system.

FIG. 4 is a schematic illustrating a log created by the system.

FIG. 5 is a schematic illustrating how information within the system may be rendered differently based on viewpoint.

FIG. 6 is a schematic illustrating a world representative of a system user.

FIG. 7 is another schematic illustrating a world within the system.

FIG. 8 is an example rendering of information within the system.

FIG. 9 is a schematic illustrating a method of curating information within the system.

FIGS. 10A through 10C are schematics illustrating a method of rendering system objects and information within the system.

FIG. 11 is a schematic illustrating example components of a computer such as a user computer.

FIG. 12 is a schematic illustrating example components of a social network server.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The disclosure describes how to analyze and process information from the internet and to display in the information to end users in a multi-dimensional manner. The present disclosure describes a computer system which may be used to present a social network to users and to present information to users.

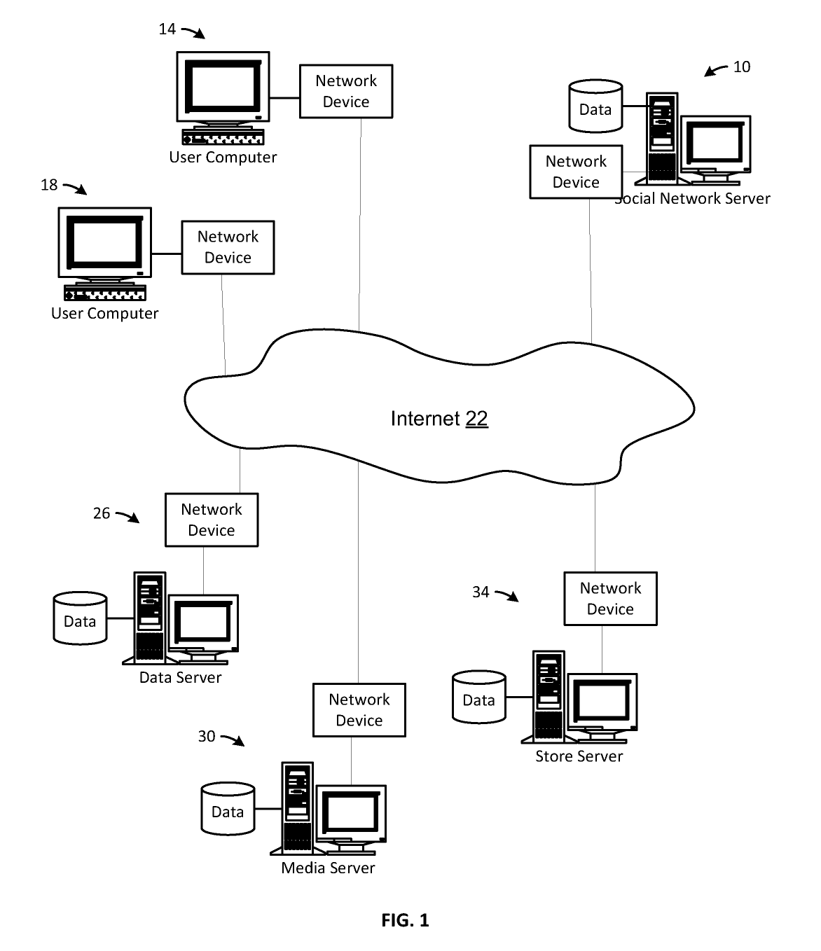

Referring to FIG. 1, a computer system is shown as may be used to implement a social media system. The computer system may include a computer such as a social media server 10. The social media server 10 may perform various tasks such as obtaining information, processing information, displaying information to users, etc. The social media server 10 may host a social media network which allows users to present information to other users, view information from other users, interact with other users, etc. Various users of the social media network are represented by computers 14, 18 as the users will use a computer to access and interact with the social media network. It will be appreciated that the various computers and servers discussed herein may be different types of devices such as desktop or laptop computers, table computers, smart phones, etc.

Users will typically interact with the social media network via the internet 22 and via social media server 10. It is understood that various network devices, routers, service providers, etc. are used to connect a computer to a server via the internet. A user will typically use a computer 14 to access the social media server 10 via the internet. The social media server 10 hosts the social media network and allows a user to interact with information on the social media network. A user may have an account with social media server 10 and may have personal information associated with the account.

The computer 14 (smart phone, tablet computer, laptop, desktop computer, etc.) typically includes a body or case which houses internal electronic s such as a processor, storage, memory, battery, communications device, etc. The computer 14 includes a user interface such as screen, keyboard, mouse, etc. The various components of the computer 14 allow the computer 14 to perform the functions and display the data discussed herein. A user may use the computer 14 to transmit information to the social media server 10 as well as to receive information from the social media server. The user may log into an account via a webpage which is hosted by the social media server in order to access the social media network.

The social media server 10 may also interact with other computers such as a data server 26, media server 30, store server 34, etc. The social media server 10 may obtain information from these different web servers 26, 30, 34 and may present information from these servers on the social media network. In one example, the social media server may represent a website or information from a website as part of a representation of a user within a social media network. The social media server 10 may display a representation of a webpage such as a store, media website, data website, etc. in relation to a user.

Users will often be involved in the exchange of information on the social media network. For example, users 14, 18 may visit other users and view information about the other users. Users may also participate in discussions, post comments, post pictures, etc. on the social media network and may direct this information to other users. Users 14, 18 will typically create a profile within the social media network which includes personal information, media, comments, discussions, photographs, etc. Additionally, a user's profile, or information about the user stored on the social media server 10, may also include browsing history and habits, purchase information, and other information about tasks, events, and occurrences within the user's life. The social media server 10 may analyze available information about the user and use this information to prepare a representation of the user/user's life.

The social media server 10 may represent a user 14 via a world which is displayed on the social media network. The world is personalized to the user and displays information, scenery, architecture, weather, etc. which is representative of the user and representative of the users surroundings, weather, events, etc. The user's world may be represented within a larger universe along with worlds representative of other users as well as other worlds representative of other websites which are associated with particular users. The universe may be displayed in a 3-dimensional manner and different worlds may be displayed with varying proximity, magnitude (size), and color to highlight the relative importance of the worlds.

A user may move through the universe of the social media network and may visit different locations (worlds) in the universe to learn about the user associated with the particular world. As a user moves through the universe, the structure of the universe changes. Different worlds in the universe (which may include worlds representative of individual human users, worlds representative of entities such as a major store, media website, etc.) may each be displayed in relation to the world where the user is visiting. Thus, in moving to different world, a user may see a universe which has a completely different structure as various worlds may have more or less relevance to the user of the visited world. The universe is thus continually redrawn and changed so that a user is presented with the portions of the universe which are connected to or relevant to the world which the user is visiting.

Some discussion of the following aspects of the disclosure is useful to provide a background and a more complete understanding of the present disclosure.

The social media network, sometimes referred to as the System—The social media network is a dynamic, living, online ecosystem, which can also mutually interact with the real world. In addition, it can form a virtual world or virtual universe.

System User (SU)—A System User may be any entity which is (or can be) mapped into the system. A System User can be a human user, an external system such as any website, search engine, algorithm, server, service provider, etc. which can interact with the system, any URI (Uniform Resource Identifier used to identify a name or web resource) or a real world object such as a store, building, monument, mountain, etc.

System Object (SO)—A System Object is an object within the system. This can represent or link to a System User or group of System Users or can be an independent object in the system, not linked to a System User. System Objects may include an avatar or any structure as an example type of system object.

Object Group (OG)—An Object Group may be a group of System Objects or group of System Users. One System Object can represent an object group.

Observer (OB)—Any entity or object that is navigating, observing, or interacting with the system. Normally, it is a human System User who is online or logged in the system.

System Engine (SE)—The System Engine is the foundation of the system. This consists of Artificial Intelligence and Collective Intelligence. (AI and CI as defined below) which can mutually interact and evolve. This engine processes, houses, analyses, interprets, curates, redistributes, renders, etc. all information, data, and metadata in the system and in the real world. Based on this, it can provide optimized and curated services (information) to each System User ubiquitously (in the system and in the real world).

Artificial Intelligence (AI)—Artificial Intelligence is intelligence that is based on learning through processing the aggregate of all information and System User interactions not only in the system but also in the real world. Collective Intelligence is also used in the learning process. Artificial Intelligence is also an active participant in the evolution of the system's Collective Intelligence described below.

Collective Intelligence (CI)—Collective Intelligence is intelligence that is based on the collaboration and competition of many system participants such as System Users. It is also an active participant in the evolution of the Artificial Intelligence mentioned above.

The system embodies a new paradigm for the presentation, creation, organization, analysis, and curation of information. It is a dynamic, living, online ecosystem, which can also mutually interact with the real world. As a result, the system improves the quality of life by ubiquitously providing optimally curated and adapted information and services to all entities including human beings.

The system presents information through the use of System Objects in multi-dimensional space. Each System User has at least one associated System Object; however, each System Object does not necessarily have a System User. Algorithms incorporating 1) information specific to each System Object (System User) and 2) information about the System Object's (System User's) relationship to other System Objects (System Users), as well as to the system as a whole, govern the physical attributes of each System Object in the system, similar to the way the laws of physics govern matter in real-life 3-dimensional space.

In one example, a System Object may be a world (planet) associated with a System User. A user's world may be customized to reflect the user's interests as well as to reflect the users location; e.g. geography, climate, weather, etc.

Specifically, these algorithms use 1) information specific to each System Object (System User) and 2) information about the System Object's (System User's) relationship to other System Objects (System Users), as well as to the system as a whole to determine variable and coefficient values for equations that describe the laws of matter within the system. For example the system may adapt and modify laws, such as Newton's laws, Coulomb's Laws, etc. in order to render System Objects in multi-dimensional space. The system uses these equations to determine the physical attributes of each System Object. Thus, the nature of each System User is precisely reflected by the attributes of the associated System Object. See below for examples of the types of information used in these algorithms. In addition, information external to the system, including but not limited to System Users' real world locations and circumstances (weather, time of day, etc.). Multiple different pieces of data associated with a System User can be used to determine the physical attributes of a System Object associated with the System User.

The attributes of a System Object may include but are not limited to the location, size, color, contour, shape, any supplemental objects directly associated with the System Object, including but not limited to a spatial ring, the placement of each System Object in relation to all other System Objects, and indicators of a given System Object's (and by extension a given System User's) relative importance in the system.

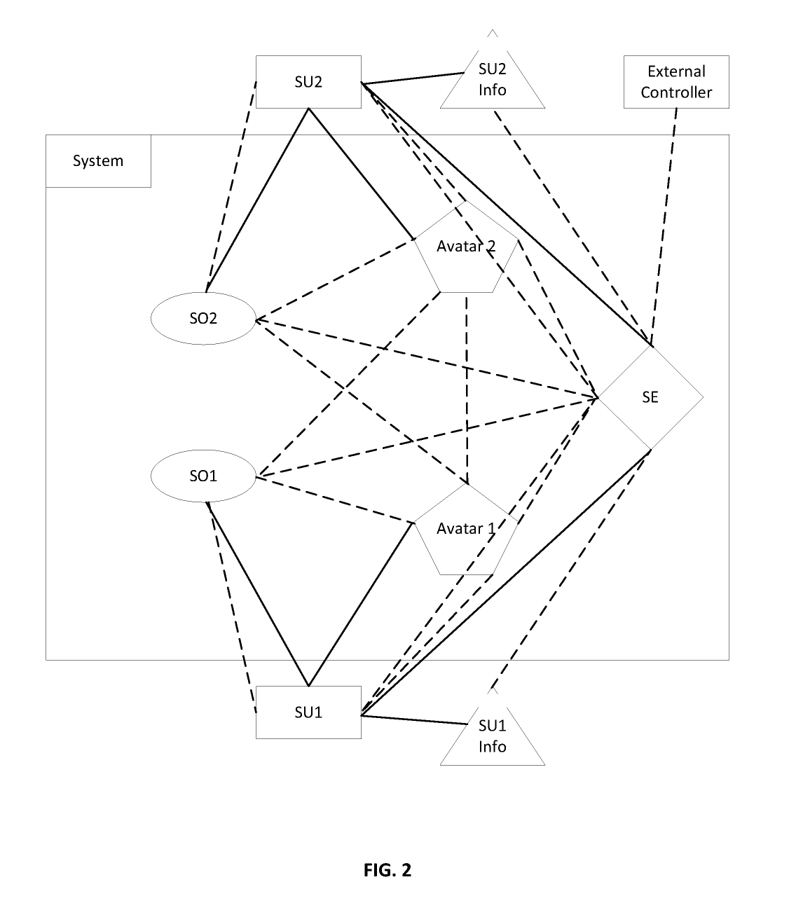

FIG. 2 explains how internal and external information may be used to generate the attributes of System Objects. FIG. 2 shows an example of connections and information flow within the system.

SU1—In this example the System User exists outside the system (i.e. a human user). However, System Users can exist within the system as well, such as a System User created by the system to represent an object outside of the system. System User 1 may be a human user who had created an account with the social media server 10 and may have interacted with the system. For example, SU1 may have entered personal information into a system profile or system account. SU1 may have also interacted with the system, such as communicating with other System Users, viewing data for other system users, etc. SU1 may have also provided additional information such as internet browsing history to the system.

SO1—SU1's associated System Object. In this example, it is where information about SU1 that exists within the system is housed. SO1 may be a world which is representative of the environment in which SU1 lives in real life. As such, the SO1 world may include buildings, geography, weather, etc. which is representative of SU1's environment.

SU1 Info—This is information about SU1 that exists outside of the system, such as SU1's real world location, the weather at that location, and the time of day.

Avatar 1—Avatar associated with SU1.

SE—The System Engine is an engine that performs necessary calculations to determine the system environment, render the system environment, and present the system environment to various users. The system engine may be implemented by the social media server 10.

External Controller—This is a controller outside the system that the System Engine can interact with in order to control real world features.

In FIG. 2, solid lines represent a direct relationship between two items. For example, the solid line existing between SU1 and SO1 represent the fact that SU1 has direct ownership over SO1. Dotted lines represent the exchange of information between different items. In this example, all items, with the exception of SUs, have a direct information exchange with the SE.

SUs may interact with the SE via avatars. If they have an associated SU, avatars have a direct relationship with that SU, yet system avatars still act autonomously and exchange information between that SU and other elements of the system (highlighted by both the solid and dotted lines between SUs and associated avatars). As shown, the SE monitors all information exchange within the system, uses that information to curate, improve, adjust, etc. the system and the cycle continues iteratively. The SE can also use information external to the System (SU1 info) to affect change within the system. Finally, the SE can affect change outside the system via a SO that represents a real world element (a non-human SU for example) or through the External Controller.

The view of all System Objects in the system is rendered based on an Observer (e.g. a human System User) and the System Users involved in the view including any System User that the Observer is currently observing. The view of System Objects may be determined by criteria including but not limited to 1) the level of access a given System User and/or Observer has to other System Users' information, 2) the link type (such as family, friend or work associate for System Objects that represent human user System Users) and link strength that exist between System Objects, 3) the amount and frequency of information exchange between System Users, and 4) what exactly the given System User or/and Observer is observing. From these criteria, the System Engine may determine how the system optimally renders the view of System Objects to the given System User/Observer. The system provides fully customized views for Observers via the ability to change, reconfigure and filter views based on an Observer's preferences. For example, an Observer can 1) zoom in to visualize an System Object's relationship with other System Objects in its immediate spatial vicinity, or zoom out and visualize the relationship an System Object has in the context of all System Objects in the system and 2) view System Objects based on the real world locations of the System Users they represent. In addition to Observer preferred views, the system can also provide a curated view to Observers (System Users) via the use of System Engine as described in Sections.

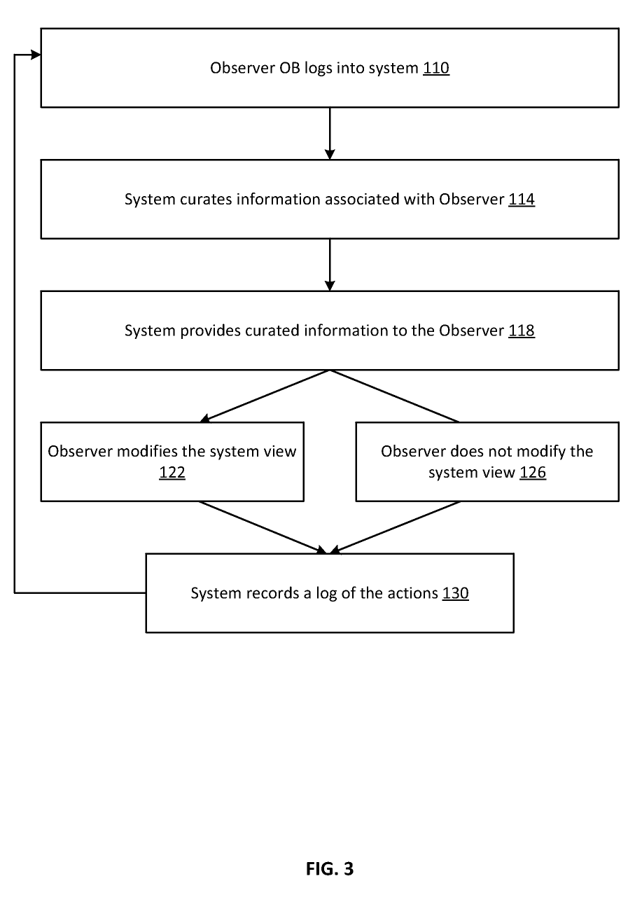

FIG. 3 further explains one potential process for how Observer views are determined. FIG. 3 illustrates a basic flowchart for rendering an Observer specific view of System Objects and Object Groups in a multidimensional space. As described, the system may also keep and log and provide information to the Observer.

An Observer may log 110 into the system, such as by logging into a user account with the social media server 10 to access the system. The system may then curate 114 (i.e. analyze) the information associated with the Observer. As such, the system may analyze the connections that exist between the Observer, System Objects, and Object Groups within the system. The system may also analyze the level of access that the Observer has been granted to other System Objects of Object Groups; either by the owners of System Objects or by the System Engine.

The System then provides 118 curated information to the Observer. The System may render a custom view of System Objects and Object Groups (sometimes simply referred to as System Objects) to the Observer according to the above criteria. The Observer may interact with the system and the presented view of System Objects and Object Groups. Often, the Observer may modify 122 the presented view of System Objects and Object Groups. The Observer may filter System Objects based on a set of criteria. Additionally, the Observer may select a specific System Object to view. Following these actions, the system may provide an updated view of the System Objects to the Observer.

The Observer may also interact with the system by interacting 126 with a particular System Object. For example, the Observer may visit a world to learn about the world and obtain information about the world (a System Object) and a System User associated with the world. At any given time, many System Users will be interacting with different elements of the system such as System Objects. Continuous interaction between System Users and System Objects will result in changes to the relationships between System Objects and will result in continuous changes to the presentation of different system objects to an Observer.

As an Observer interacts with the system, the system may record 130 a log of the actions taken by the Observer. The log may include a complete record of all System Objects selected by the Observer, the System Object's information, the relationships between System Objects, and a timestamp of the actions taken by the Observer. The log can be saved by the system and may be later revisited, reviewed, or interpreted by the Observer.

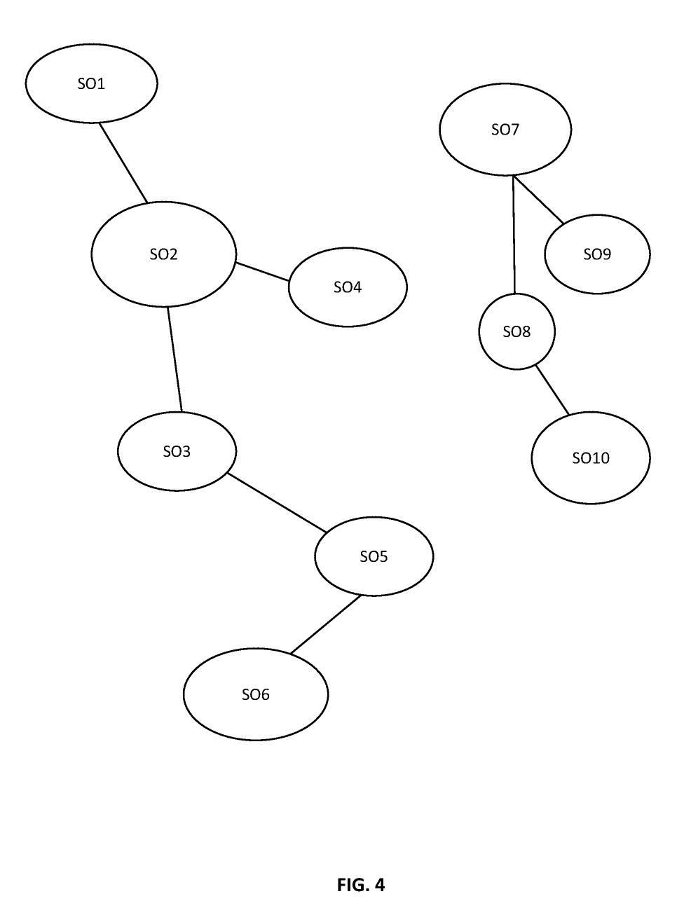

FIG. 4 shows an example of a log. The log traces an Observer's actions (as well as several other pieces of system information) as the Observer moves from a SO to another SO at a given point in time. It provides a snapshot of the relationships between SOs that the Observer viewed. The Observer can then revisit, review, and analyze the log. For example, the Observer can view how relationships evolve between SOs over time by viewing the log at the point at which it was created (the past) and then at several points after that, up to and including the present point in time. In addition, the same laws that apply to rendering multi-dimension space can also apply to the log.

The system provides Observers with the ability to easily recognize System Objects (and associated System Users) of particular importance and relevance to a given System Object (and associated System User). The system may create links between System Objects to show important relationships between these System Objects. These links can be specified by System Users or can be generated by the System Engine. As an example, a link between System Objects, as well as a link type can be presented via the use of a connecting indicator, such as a line. A link between System Objects may be represented with the rotation of other System Objects about a selected or visited System Object from which the system is being viewed. In this manner, the representation of links/relationships between system objects may change depending on the viewpoint in observing the system. For example, Object A may be of large importance to Object B while Object B is not of large importance to Object A. Importance is typically due to a System User associated with the System Object significantly interacting with the other System Object or assigning a relationship to that object. Thus, when Object A is viewed, Object B may not be seen or may appear small, distant, or unconnected. When Object B is viewed, Object A may appear close or large and may be connected to Object B with a line or may be orbiting Object B.

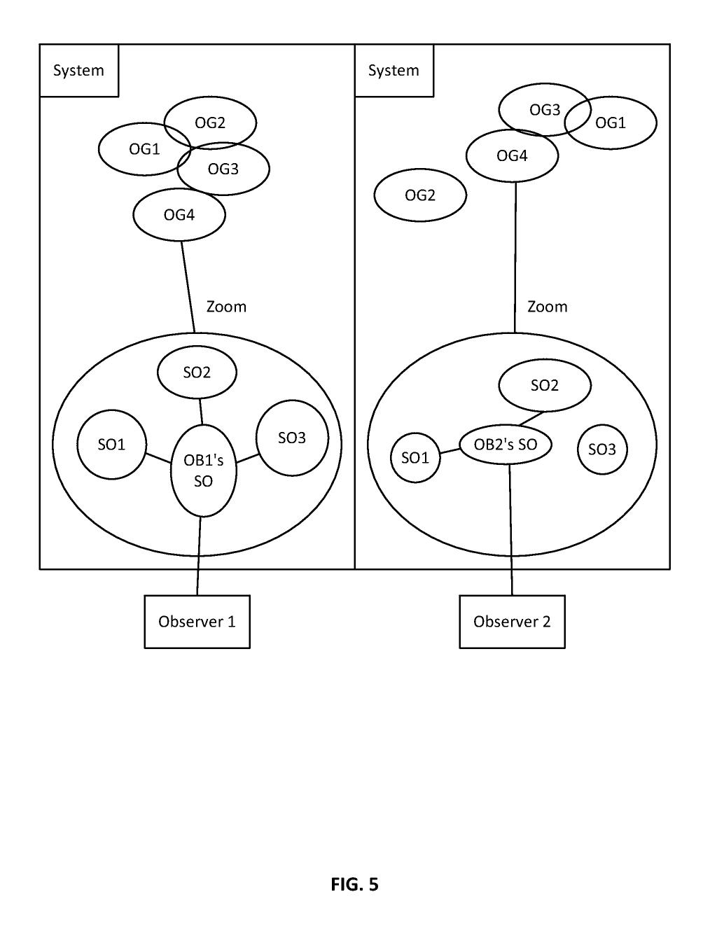

FIG. 5 provides an example of links between System Objects and how they differ based on the Observer. FIG. 5 shows a schematic of contrasted system views, illustrating how the same System Objects might be presented differently to different Observers or to an Observer while in different locations in the system. Observer 1, or a System User observing the system from a System Object related to Observer 1, might see SO1, SO2, and SO3 connected to the System Object related to Observer 1. Observer 2, or a System User observing the system from a System Object related to Observer 2, might see SO1 and SO2 connected to the System Object related to Observer 2 and might see SO3 not connected to the System Object related to Observer 2. This would be due to the lack of relationship between Observer 2 and SO3. Additionally, influence, connectedness, and relationships between the different System Objects may be shown as relative sizes of System Objects, proximity between System Objects, and lines connecting System Objects.

In addition to providing the ability for Observers to visualize characteristics of the relationship between System Objects, the system provides Observers the ability to visualize the relationships and interactions between groups of System Objects, or Object Groups, as well as how these Object Groups relate to other Object Groups and the system as a whole. Object Groups have particular attributes, including but not limited to size, color, shape, and orientation. These attributes are based on the relationship each System Object in the group has to the other System Objects in that group, per the methodology described herein.

An Observer can explore and navigate through the multidimensional space of the system. An example of this is being “transported” to a given System Object or location in multidimensional space through selecting a System Object or any supplemental objects associated with a System Object. The Observer can then select yet another System Object and be transported accordingly. An indexed record of transportation from System Object to System Object or location to location, also known as a log, is created and stored so that the Observer can revisit the path taken to arrive at a specific System Object or location, similar to a navigation history.

System Objects not only serve as representations of System Users but as a space in which System Users can store information, including but not limited to photos, text, videos, records of interactions with other System Users, and preferences. In addition, the space can also store curated information based on the information mentioned above. In the space, there can be other System Objects such as avatars and structures for processing and housing the different types of information which are governed by the same system algorithms that orient the objects discussed in Section A. In addition, a System User can customize the space including the avatars and structures to fit an individual System User's preference. For example, the associated System User can create System Objects and change attributes of System Objects based on the preference. However, each System User may have a different level of authorization in customization.

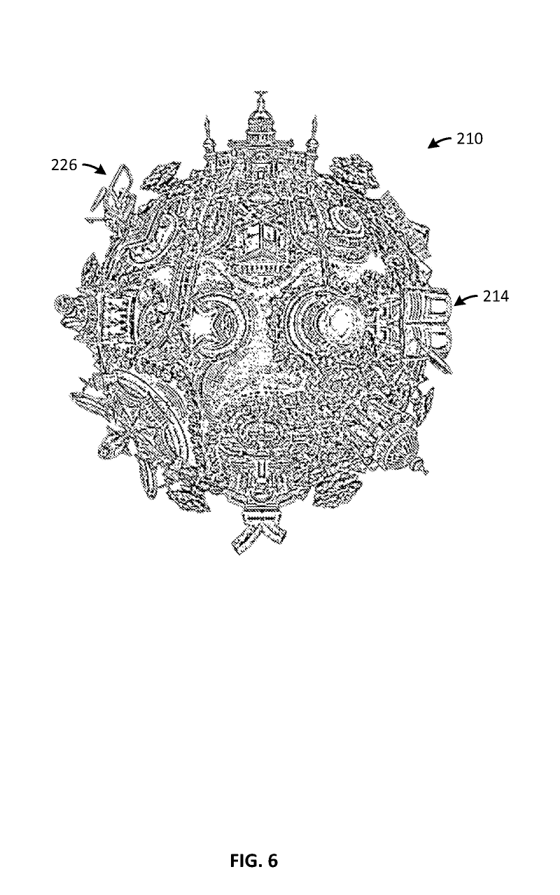

FIG. 6 provides an example of a System Object and associated structures. The example System Object is displayed as a world 210 and structures associated with the System object are displayed as buildings. Different buildings may be selected according to the different needs of a System User.

The information in a System Object may be presented when an Observer (e.g. a System User) selects that System Object. In addition, some information may be presented by the System Engine without action from an Observer (System User). For the given System Object space, each System User may have a different level of access authorization such that some System Users can access all information but others cannot. For a given System User, the System User may have different levels of access authorization through System Objects. The accessibility is determined by criteria such as, but not limited to, the particular type of relationship, connection, and links between System Objects. A System User can specify which users it would like to grant private access to, but the number may be limited. For URIs, the system incorporates functionality that converts URIs to System Objects as well as wholly independent multi-dimensional spaces with system characteristics and attributes that parallel those described throughout this summary.

The world 210 (a System Object) may have structures which are representative of their functionality and may, overall, be representative of the System User associated with the world. Thus, the world 210 may include a mailbox 226 which is used by the System User to send and receive messages. The mailbox may be limited to System Users who have a connection to the User associated with the world 210. The world 210 may also have a guest log or visitor registry 214 where visiting avatars are able to leave messages. The world 210 may be representative of the real world location where the associated System User lives. Structures on a User's world 210 may be representative of information which the AI has determined to be relevant to the User and may be used to deliver that information to the user. Thus, the type or quantity of the buildings, trees, river, etc. may be modified to represent the location where the associated User lives. Additionally, characteristics of the world 210 may reflect the weather, night/day, seasons, etc. of the location where the associated User lives. The System Engine may obtain information from the associated User such as their residence location or GPS coordinates and use this information to render the world 210.

Thus, rendering different System Objects associated with System Users, online data/information, etc. in 3-dimensional space provides an increased ability to view and understand the data to Users. Information and data are housed in Objects whose size, location in 3-dimensional space, and appearance in relation to other objects in the system are based on the relevance of the information and data that the Objects houses. Relevance is determined by the AI and learning algorithms described herein. As an example, if an object houses information about another User whom an Observer is close friends with, that object will be larger and located more closely to the Observer's object than an object that houses information from another User whom the Observer is not close with. The system may treat an individual webpage from a site as an object and display that object close to a user's planet if the AI or learning algorithms have determined that the page is relevant to the user. The system may allow a user to browse to that website page by clicking on, touching, moving to that Object in the social network. If the Observer frequents a website, the object that represents the website will be closer in proximity to the Observer. The information within the website's object will be a reflection of the information on that site that is relevant to the Observer. If for example, the Observer visits the “world” tab of cnn.com frequently, that is the information that will be housed in the object that appears close to the Observer's object (not the entirety of the cnn.com website, only the information/data/content that is relevant to the Observer). This allows an Observer to conceptualize the relevance of online data to other data visually. This provides an added layer of context and allows for easier discovery of relevant online information through visual search.

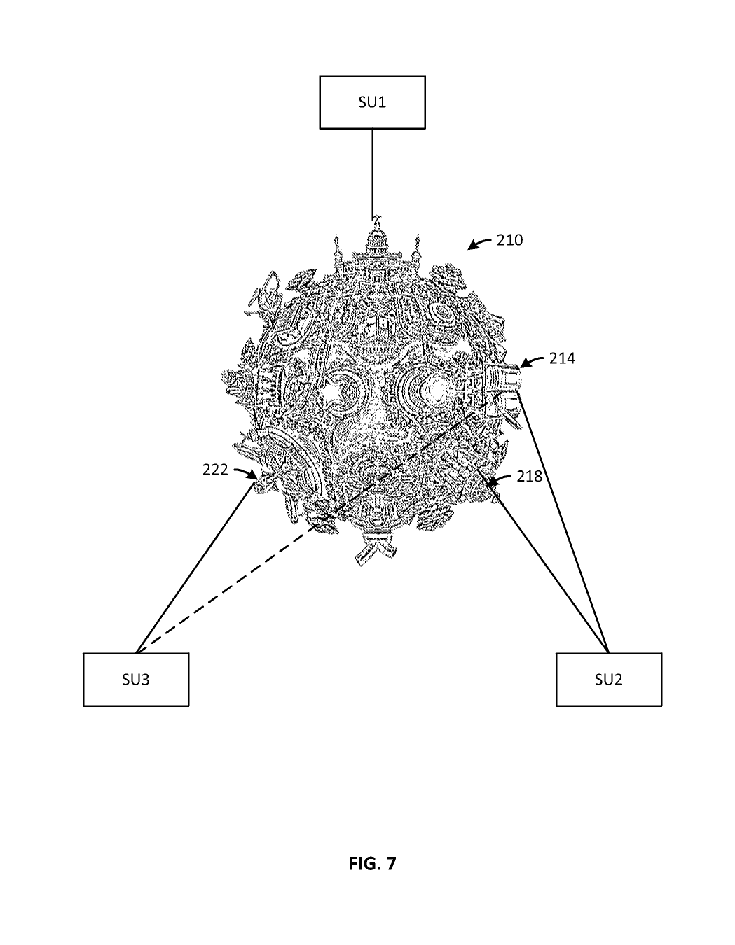

FIG. 7 provides an example of how different levels of access determine what information can be accessed by different System Users. SU1 is the owner of the System Object 210, and has access to all structures on the System Object. SU2 has access to information contained within Structure 214 and Structure 218. SU3 has access to information contained within Structure 222.

Additionally, the system may provide for varying ways to manage user access to data. Particularly, the system may provide for segregation between public and private data. The system may segregate a User's relationships with others into “friends” and “observers”. A user may be permitted to have an unlimited number of observers that can view public content, but only a fixed number of friends such as 30 friends who can view private content. When content is posted, it is posted as public or private and there is no need to specify who can see what, as it is built into the system.

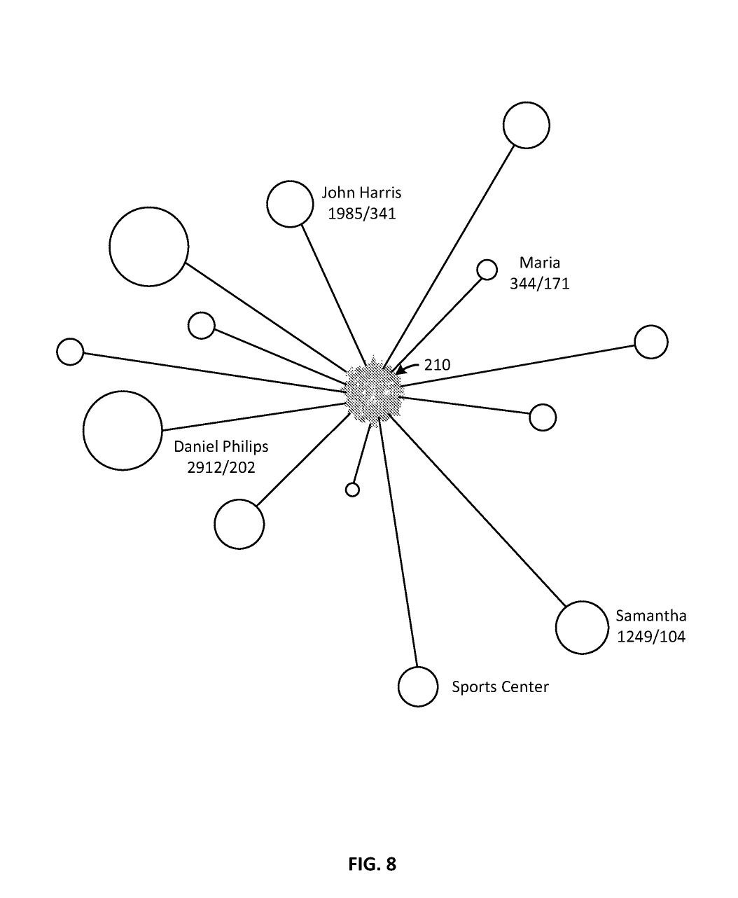

FIG. 8 illustrates a view of the social media system as may be presented to an Observer such as a System User. In one example, the social media system may be presented to an Observer as a universe. Within the universe of the social media network, System Objects may be presented to an Observer in a few different ways depending on the vantage point of the Observer. For example, System Objects may be presented to an Observer as planets. Moreover, the grouping and association of System Objects as well as the connections between these objects may change depending on the vantage point of the Observer. An Observer will typically select a particular System Object to form the center of their view of the social media system. That Object will be typically be placed in the center of the screen. Additionally, that Object will typically be drawn as a planet and will show some details of structure such as buildings on the planet. Other System Objects which are related to or connected to the selected Object may be drawn as planets which surround the selected Object, but may be drawn with less detail, such as being drawn as a colored sphere. Thus, distinctions in rendering an object may be made based on whether or not a System Object is selected as the center of focus and not based on the type of Object.

System Objects will often be associated with a System User. Thus, many system objects are associated with and representative of a human System User. Other System Objects may be associated with a non-human entity such as a website.

Other System Objects around the selected Object may be arranged or grouped for consistency according to other relationships that those System Objects have, such as connections to other System Objects. The surrounding System Objects may be connected to the selected Object by lines to show relationships between the selected System Object and other System Objects. The distances between the selected Object and the other System Objects may be representative of the closeness of the relationship between the selected Object and the other System Objects. Thus, close friends or family or System Objects with which the System User associated with the selected Object interacts with frequently may be represented by Objects which are drawn closely to the selected Object while more distant acquaintances may be drawn farther away. System Objects representing a website such as a store, news site, forum, etc. may be drawn with a distance away from the selected Object which is representative of how frequently the System Users associated with the selected Object visits the website and how much time is spent there.

Viewing a System Object thus allows an Observer to easily see how many other objects (i.e. Users and entities) are associated with or connected to that System Object (I.e. User) but to also easily see how important or influential each of those other objects are, what type of entities are represented by those Objects, and how closely those other System Objects are connected to the observed System Object/User. The system is dynamic and constantly adapts to the actions of System Users. In the context of rendered views of the social network, distances between System Objects will constantly change based on interactions between those objects. The sizes of System Objects will constantly change based on the interactions with other System Objects/Users.

The display characteristics of the system allow for various advantages. For example, a search engine feature may be implemented which allows a System User to search for a System Object (including an Object representative of a website) based on desired search terms. The System User may also search based on characteristics within the social network system including connections, etc. Thus, a System User may alter a typical search based on connectedness of the result Objects, type of object, size of the object, etc. Additionally, the System User may then view search results and system objects in different ways. Rather than simply looking through a page of results, a System User may browse according to relationships. The System User may select a System Object from the search results which is a good result and observe the system from the vantage point of that Object. Then, the System User may browse other System Objects which are close to or connected to the result Object.

System Objects surrounding the selected Object may each be drawn with different sizes and colors to represent attributes of the System Object. For example, size may indicate the influence of an Object (i.e. the influence of the entity represented by the Object) and colors may represent different types of Objects (e.g. human user, store, news site, etc.).

Non-human system objects may be rendered in a way which is consistent with the overall feel of the system. Thus, a store website may be rendered as a world with a large store building where a user can look at prominent selected objects in a 3-D gallery type view. A news website may be represented as a world with a large news stand or billboard where headlines and a representative image are displayed to an observer.

Within the system, System Users can interact with each other in various ways, including but not limited to voice, video, and text communication, content sharing and discovery, polling and curating, etc. . . . Data and metadata about System User interactions with System Objects, Object Groups, and the System Engine as well as System User information within the system is the foundation for the continued dynamic growth of the system itself. As a result of System User behavior, new System Objects and Object Groups can be created and strategically placed within the system and pre-existing System Objects and Object Groups can be modified. The system is directly shaped by each and every activity System Users take; much like a real-world ecosystem evolves based on the activities of the organisms within it. Every System User participates in this constant feedback and reshaping of the ecosystem, but with differing levels of influence. For example, the activities of a System User with comparatively more and stronger links to other System Users (via their System Objects), with more credibility as determined by other System Users or the System Engine, or in the case of System Users that are URIs, more site visits, will shape and reshape the system to a greater degree than one with less of these things.

Life-like entities, or avatars, inhabit the system. These entities can represent System Users and/or can be wholly independent entities. They are directly connected to the System Engine and are one mechanism through which information is managed, collected, interpreted, filtered, analyzed, regenerated, curated, distributed, presented, etc. . . . As a result, these entities help the System Engine to manage and evolve Artificial Intelligence and Collective Intelligence, and to provide optimized services to System Users. Through their connection to both other System Users and the System Engine, these entities serve as the bidirectional interface for human/System Engine interaction within the system.

In one example, avatars are each embodiments of the system Artificial Intelligence and discussion of learning through avatars applies to the Artificial Intelligence of the system and vice versa.

Avatars are unique in that they are entities which are representative of System Users but, in many ways, they are controlled by the system. A human System User will typically have an avatar as well as a System Object such as a planet/world associated with their account with the social media server 10. For a human System User, their avatar is typically a physical representation of the user. The avatar may represent actions taken by the user. If the user was to go visit someone else's node (world, planet), their avatar would be represented on the other person's planet and the other person would see it there. If a user purchases a product such as a pair of shoes, the their Avatar can be rendered as wearing those shoes by the SE. In a System User's own planet, they may interact with their own avatar. The avatar is tied to back end AI engine and can access all data in the system environment and can present information to the user associated with the avatar as well as to other users. For example, a user's avatar may engage the user and interact with them. The avatar may deliver news to the user, such as “Hey, here are pictures from Friend's trip to Hawaii . . . . ”

Since the avatar is connected to the artificial intelligence in the System Engine, it can learn what its user is interested in and give this information to the user. Thus, a user may access information and directly obtain information from the internet and from the system and the AI engine/avatar may learn what information the user wants to see from the actions of the user and deliver it to the user. The user's avatar is the interface for interacting with the network and is the representation of the user to other users in the network. A System User's avatar is connected to and has access to their online social interactions and all of this information is used to build the AI in the avatar. Thus, the avatar is an independent entity that has access about the System User and interacts with the System User. The avatar is created around the user according to user characteristics, but the user is not directly in control of the avatar. The user can move it around, visit places, etc. It then interacts with the user and provides data to the user based on their likes, dislikes, preferences, history, etc.

The avatar is a physical representation of the information that is available to it. If a user takes an action in a planet, (like a photo, etc.) their avatar is taking an action on that avatar. On the back end, the system is recording the action and applying it to the appropriate user profile.

One feature of the System Engine is to curate all kinds of information, and provide optimally curated information and services to System Users in various ways. Curation describes a manner of managing information where the system actively sorts through information and selects particular information for presentation to a user. Rather than a System User selecting items to be included in a newsfeed, the system selects items to present to a User based on that User's viewing habits. The curation consists of many processes such as, but not limited to, housing, analyzing, filtering, interpreting, learning, reproducing, and distributing information (data, experience, knowledge, wisdom, etc. . . . ). The information can be from the contents in System Object space and from any System User actions, activities, and interactions not only in the system but also in the real world. The System Engine uses highly specialized and evolving algorithms to interpret all actions, information, information flow, iterative feedback, and any and all activities in the system and in the real world. This pushes the constant evolution of the system.

The curation helps the System Engine control many aspects of the system and the real world. For example, in the system, the System Engine can control the attributes of System Objects and the law of physics that governs the multi-dimensional space based on curation. In addition, the System Engine provides optimally curated information to a System User, without or before request for this information. Furthermore, based on the curated information for the System User, the System Engine can provide “real services” by controlling the environment of a place the System User may be interested in, such as the exact physical location of the System User, a remote house, etc. This can be accomplished by cooperating with a System Object representing the place in the system or by cooperating with a unit in the real world which controls the environment of the place. The services can be, but are not limited to, controlling lights, advertisements, music, temperature, humidity, the color of the environment, and even providing a recommended menu choice.

Not only the System Engine but also System Users can participate in curation. In addition, System Users can teach System Engine how to curate. Further, the System Engine learns how to optimally curate by observing System Users in various ways. The participation of System Users in curation is essential in Collective Intelligence evolution. Learning or teaching about know-how such as how to curate, what to curate, for who to curate, etc. . . . contributes to Artificial Intelligence evolution. Both participation and learning/teaching processes are mutually interconnected. Thus better learning process based on Collective Intelligence accelerates the Artificial Intelligence evolution and better Artificial Intelligence reciprocally accelerates the Collective Intelligence evolution. This happens iteratively and the system evolves.

All entities including System Users can interact with the System Engine directly. During the direct interaction, entities curate the data and can teach the System Engine how to curate. In addition, the System Engine can also semi-directly learn through the avatars mentioned in Section I, as well as through other System Objects. The avatars serve as the interface between System Engine and System Users. They measure and monitor all activities of System Users on behalf of the System Engine and also learn about System Users to provide tailored interface or curation for not only the System Users they are representing but also other System Users they are interacting with. Also, the System Engine can indirectly learn through monitoring or measuring the aggregate of all activities, contents and information generated, curated or provided by System Users. These direct, semi-direct, and indirect learning processes can be used in combination. Furthermore, when the System Engine needs more help from outside, it can also send requests through avatars or directly contact entities such as System User(s), System Object(s), or Object Group(s). Thus the learning process is bidirectional. More importantly, each interaction is treated or weighted differently based on the strength of a System User, System Object, or Object Group's influence.

Thus, curation and interaction with the system by System Users is an important part of the Artificial Intelligence of the system. Artificial Intelligence and learning may include all user activity (which may include but is not limited to normal browsing, social activity, and mobile activity i.e. GPS), and this activity is taken into account in an algorithm that weights the relevance of information to a user. In taking all of this activity into account, the algorithm learns significantly about the user's preferences. There are two major factors that impact the relevance of information to a user: a) the actions that a user has directly taken and b) the actions that others users have taken. For example, if a user is friends with another user and that user frequents a website, the website's relevance will increase as it relates to the first user based on their friend's actions. This may extrapolate out to the second degree as well; if a friend of a friend frequents a website, the relevance increases for the user as well. In this way, the learning algorithm is constantly optimizing what information is relevant based on the actions all users are taking in the system.

The effect that friend's habits will have in changing the relevance of information to a particular user may be weighted according to the strength and proximity of the relationship between the user and friend, their degree of interaction, etc. In this manner, all information about user activity in the system is relevant to each and every user in the system. The activity of any user may be weighted according to that user's influence, proximity, and degree of interaction with a particular User in determining how to change how information is delivered to the particular User. Optimizing content with this methodology will provide a better, more highly curated user experience and increase the relevance of the content viewed by users

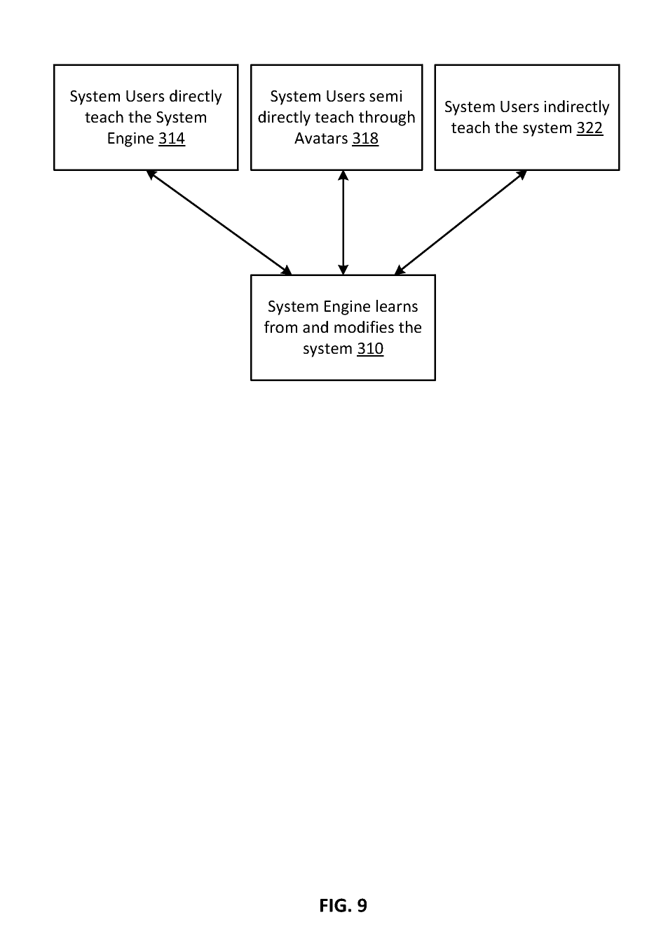

FIG. 9 illustrates Curation flow within the system, and illustrates how the System Engine learns how to curate information from different aspects or tasks occurring within the system. As indicated at 310, the System Engine learns from the system. One aspect is that the System Engine adapts to provide optimally curated information to System Users. Another Aspect is that the System Engine optimizes then modifies the system itself, including Avatars and the size, position, and connectedness between System Objects.

As indicated at 314, the System Engine may learn directly from System Users. Content can be created and curated by System Users where System Users create System Objects, share preferences, and send information directly to other System Users. All of these activities are monitored, interpreted and acted upon by the System Engine such that the System Engine adapts to provide the information, preferences, etc. as requested by the System User. The overall goal of the system is to create an environment that incorporates human/System Engine organization in a constant feedback loop to provide optimally curated content (social content, web content, real world information and services, etc. . . . ) to System Users.

As indicated at 318, the System Engine may learn semi-directly from System Users; such as where System Users interact with Avatars within the system. Avatars may provide information to System Users and interact with System Users. The system may monitor the response of the System User to the Avatar; such as measuring the degree of interaction between the System User and the Avatar. The system may also monitor the response of the System User to the information provided by the Avatar; such as monitoring the time spent interacting with the information or the depth interaction with the information. The System Engine may, from these interactions, modify how Avatars interact generally or with a particular System User specifically as well as how information is presented generally or specifically. General modifications to the system may be weighted according to a System User's overall influence within the system.

As indicated at 322, the System Engine may learn indirectly from the system. The System Engine may monitor System User's interactions with System Objects as well as monitor the System User's activities which are external to the system. The system may be updated according to these interactions. For example, a System User may frequently visit a particular sports website. The system may, through the System User's browser history, obtain and analyze the System User's visiting habits and identify the sports website. The system may determine that the sports website is an important part of the System User's lifestyle and may create a System Object to represent the sports website and place this object in an appropriate location and connection relative to the System User. The system may also determine the particular times of day when the System User visits the sports website and, at these times of day, obtain news updates from the sports website and present these to the System User.

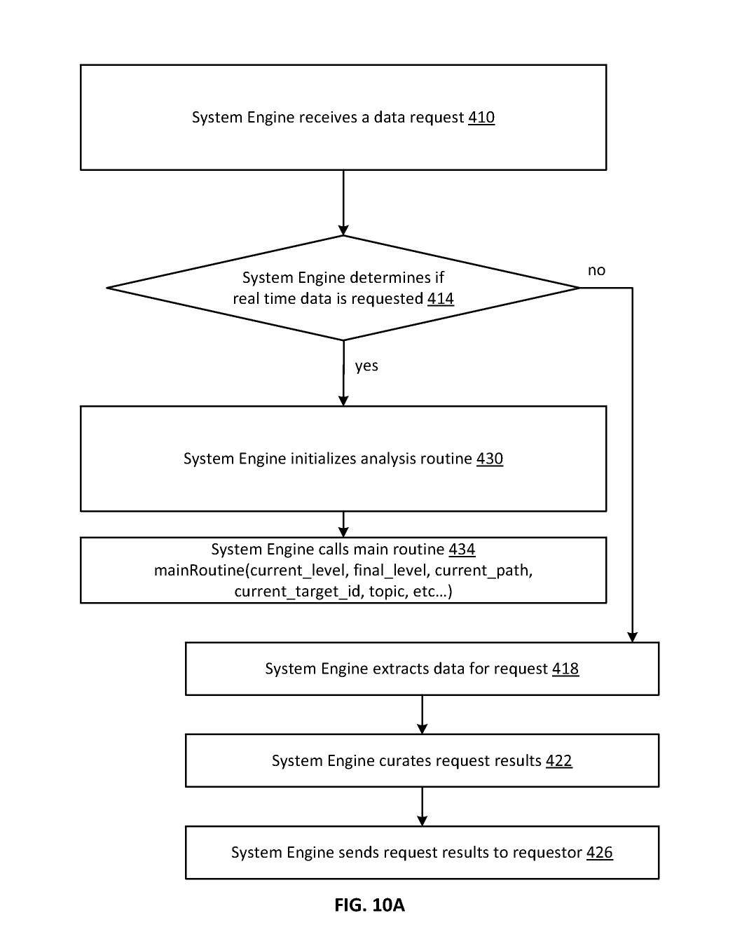

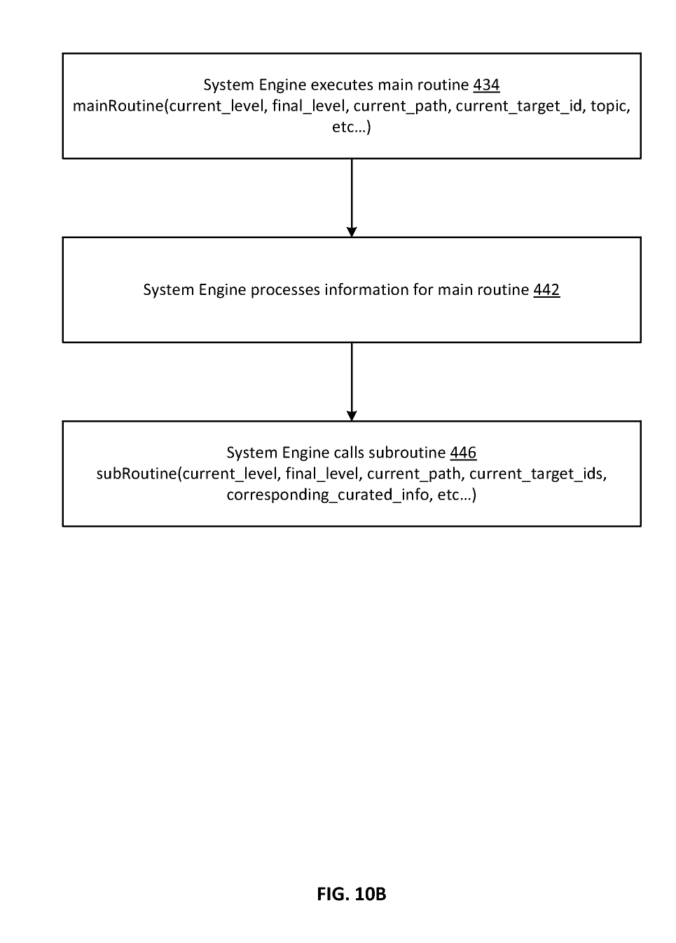

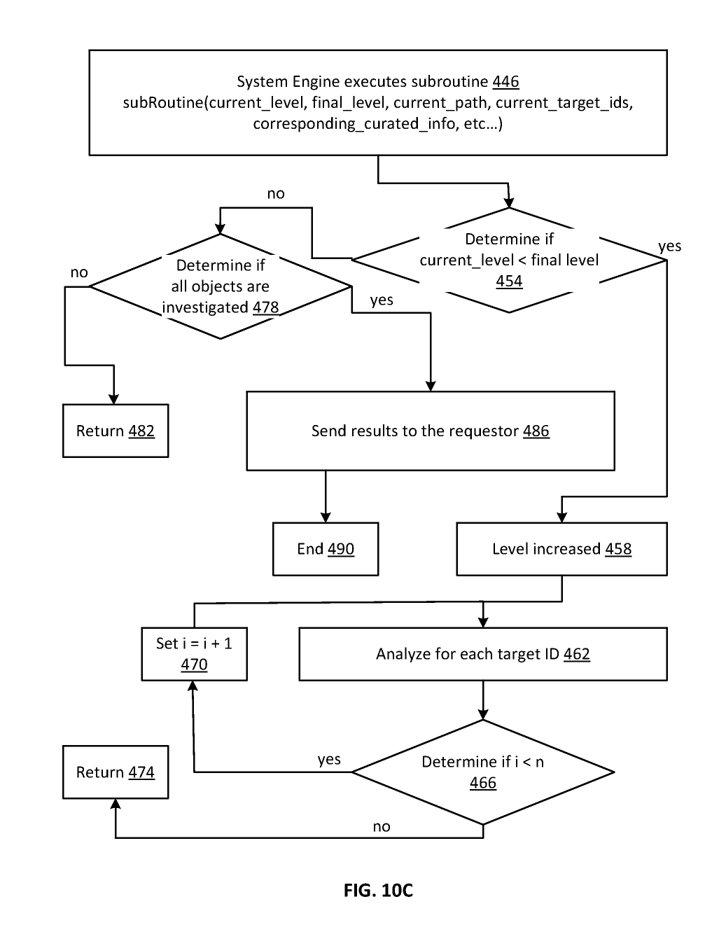

FIGS. 10A through 10C illustrate an example methodology for rendering multi-dimensional space with curated content and information. These figures illustrate an iterative process which the system (i.e. the social media server 10) may undergo to monitor, gather, analyze, and provide optimally curated data to System Users.

The System Engine (e.g. the social media server 10) may receive 410 a data request for rendering and displaying the social media universe. For example, a data request may be a request by an Observer to view a particular world and certain other worlds surrounding it. A data request may be a request to view selected types of Objects (e.g. football players, males, restaurants, friends with a particular characteristic, etc.) surrounding a certain world and within certain relationship distances of the world. A data request may include different pieces of data which form part of the request. For example, the data request may include a Target Object ID which is the unique ID for the object from which the investigation will start, or the zone ID (e.g. area or location ID) where the investigation will start. Thus, the Target Object ID may correspond to a world or area which an Observer has requested for display. The data request may also include a Request ID which is a unique identification code representing the request. The data request may also include a Requestor ID which may represent the Observer that made the request. In one example, the Requestor ID may be the user name of the Observer.

The data request may also include a Topic which identifies the subject of the request. For example, the topic may be friends, clubs, observers, followers, movies, etc. The topic may be used as part of a data request to identify a type of Object of other item associated with the Target Object ID. If no Topic is provided, a default topic such as friends may be used. The request may also include a Start Level; a level at which the System Engine will start investigating. If none is present, a default value of 0 may be used. The data request may also include a Final Level; a level at which the SE will stop investigating. If none is present, a default value may be used. As regards levels, one level represents SOs or SUs which have a direct relation to the currently investigated object. Thus, a Start Level of 0 would start investigating at the level of the Target Object while a Start Level of 1 would start investigating 1 level or connection away from the Target Object. A Final Level of 5 would stop investigating at 5 levels or connections away from the Target Object. The SE may implement a modified search algorithm, such as by modifying the search criteria by another factor such as fame. For such an example, the SE may increase the Final Level according to the fame of an Object. For a Final Level of 5, the SE may use a Final Level of 10 for popular Objects and a Final Level of 40 for famous Objects.

After receiving a data request, the SE may determine 414 if the data request is requesting real time data results. The SE may determine if the request is based on previous results for the same requestor or another User with similar request details. The SE may also determine if previous results exist for such a request and, if so, whether or not the results are valid. Previous request results may not be valid if they are too old. The SE may have a setting such as a time setting (e.g. 3 minute valid time for results) or other conditions which prevent the SE from using previous results.

If the data request does not request real time data, the SE may extract 418 results relating to the current request from system databases. The SE may then curate 422 or process the extracted results. In curating the results, the SE may apply curation rules and characteristics determined by the SE in response to system interactions and interactions of the requestor as discussed herein. The SE may then send 426 the results to the requestor.

If the data request does request real time data, the SE may initialize 430 an analysis routine to process the data request. The SE may 1) initialize a VIP (very important planet/world) list which will track the VIPs based on the current topic of investigation. For example, if the SE is tracking golf based on a data request, the VIPs may include golf pros. The SE may have a default setting where VIPs are tracked according to their public fame. The SE may 2) initialize all variables including a data buffer for saving search results. The data buffer may be a global object variable or buffer. The SE may 3) save the request details including the Final Level for objects. The SE may 4) retrieve all relation based objects of the target object (i.e. the object that the Observer is interested in) and save these into target objects variables. The SE may 5) set and initialize all variables from the data request as discussed above. If variables are not present in the request, the SE may use default variables. The SE may 6) restrict the number of VIPs which are tacked by the analysis. Once the SE is initialized, the SE may call 434 a main analysis routine. In this example, the analysis routine is mainRoutine(current_level, final_level, current_path, current_target_id, topic, etc. . . . )

FIG. 10B illustrates the mainRoutine, continusing from FIG. 10A. As indicated, the SE may execute 434 the mainRoutine(current_level, final_level, current_path, current_target_id, topic, etc. . . . ). As indicated at 442, the SE ma process information and may 1) gather all raw information (data) which is related to the topic from directly related SOs of the Target Object corresponding to the current_target_id. Some or all of the raw information can be previously curated information (data). The SE may 2) curate the raw information to provide optimized information to the requestor according to request details. The SE may 3) save the curated outcomes, corresponding object ID among the directly related SOs, and path information into an object variable called corresponding_curated_info. The SE may 4) save (update) the curated information (outcomes) and corresponding data, such as directly related object IDs and their detailed information, path information, curated conditions, etc. into results_object. The SE can also save the data and/or results_object without additional curation if desired. The SE may 5) use previously curated information and/or results if some conditions are met. The SE may 6) limit the number of objects among the directly related objects for a next level or round in the analysis, or may choose all of these objects for the next level in the analysis. These objects may be saved as current_target_ids. The order of the objects in the current_target_ids may be based on curation. The SE may then call 446 an analysis subroutine with the variables. In this example, the subroutine is subRoutine(current_level, final_level, current_path, current_target_ids, corresponding_curated_info, etc. . . . )

FIG. 10C illustrates the subroutine, continuing from FIG. 10B. As indicated, the SE may execute 446 the subRoutine(current_level, final_level, current_path, current_target_ids, corresponding_curated_info, etc. . . . ). The SE may determine 454 if the current_level is < the final_level. If yes, the SE may proceed to step 458 where the SE may 1) increase current_level by 1 and 2) set i=0 and n=total number of objects in current_target_ids. The SE may then analyze 462 for each target id i. The SE may 1) set current_target_id=i^{th} object id in current_target_ids array (in this case 0^{th} object is the first object in the array). The SE may 2) update the path information for the object corresponding to current_target_id (e.g. 1:2:5 which is the 1st object's 2^{nd} object's 5th object) based on curation results or the investigation topic. The SE may 3) update the VIP list, including this object, based on corresponding curated information from corresponding_curated_info. The SE may 4) execute additional curation if necessary and, as a result, results_object may be updated if necessary. For example, if curation depends on VIP lists, level specific condition, or path specific condition, then the SE may execute additional curation. The SE may 5) call mainRoutine(current_level, final_level, current_path, current_target_id, topic, etc. . . . ).

The SE may determine 466 if i<n. If yes, then the SE may set 470 i=i+1. The SE may then analyze 462 as described for the new value of I and determines 466 if i<n. If no, then the SE returns 474 to execute 450 the subRoutine function. The SE may determine 454 if the current_level is < the final_level. If no, the SE may determine 478 if all objects in all levels are investigated, or if the current investigation satisfies end_investigation criteria. If no, the SE may return 482 to execute 450 the subRoutine function. If yes, the SE may serve 486 the investigation results to the requestor. The SE may 1) send investigation results including detailed information related to the objects in the VIP list to the requestor. The SE may limit the number of VIP objects or the amount of information (such as names, scores, corresponding curated information, etc.) which is sent to the requestor. The SE may 2) save the investigation results into server databases with information such as a time stamp and environment (variables), investigating conditions (level, interest, VIPs, etc.). When complete, the SE may end 490 the analysis routine. This process allows the SE (as may be implemented by the social media server 10) to receive a request from an observer and process the request, analyzing System Objects and identifying System Objects which match request criteria and which are located within specified relationship distances from a System Object or view.

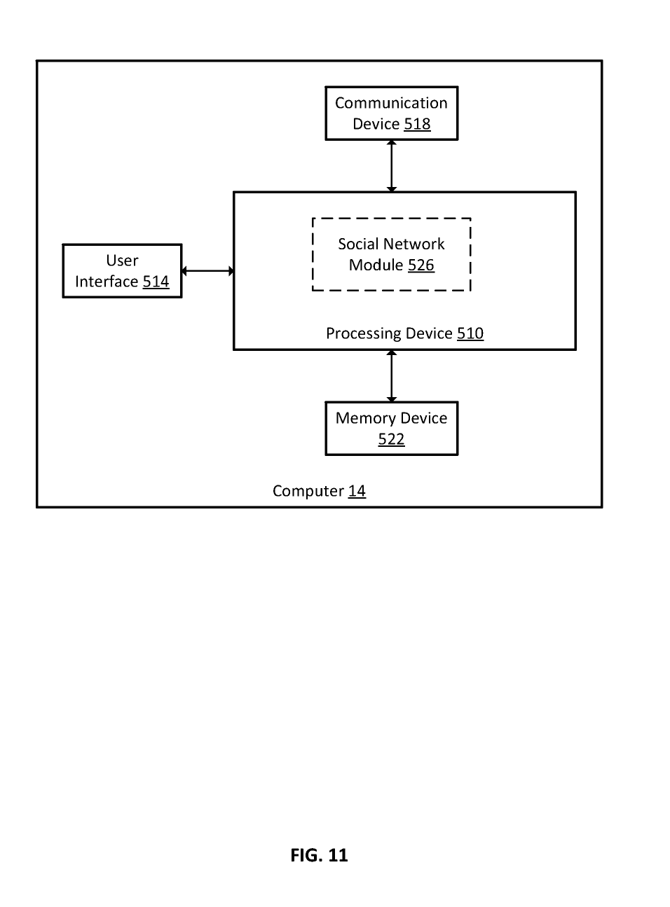

Referring now to FIG. 11, a schematic illustrating example components of a computer 14 such as a computer belonging to a System User is shown. As discussed, the computer 14 may be a desktop or laptop computer, tablet computer, smart phone, etc. The computer 14 includes a processing device 510, a user interface 514, a communication device 518, and a memory device 522. It is noted that the computer 14 can include other components and some of the components may not be required.

The processing device 510 can include memory, e.g., read only memory (ROM) and random access memory (RAM), storing processor-executable instructions and one or more processors that execute the processor-executable instructions. In embodiments where the processing device 510 includes two or more processors, the processors can operate in a parallel or distributed manner. The processing device 510 can execute the operating system of the computer 14. In one example, the processing device 510 may also executes a social network software module 526 which may allow the computer 14 to communicate with the social media server 10 and which may allow the human user to, via the computer 14, interact with the social network as described herein. The computer 14 may allow the human user to receive data from the social media server 10 to present parts of the social media network (i.e. the system or universe) to the user. The computer 14 may allow the human user to enter information, select information, and transmit information to the social media server as discussed herein. The social network software module 526 may execute some of the functions described herein so as to allow a human user to engage and interact with the social media network as discussed.

The user interface 514 is a device that allows a user to interact with the computer 14. While one user interface 514 is shown, the term “user interface” can include, but is not limited to, a touch screen, a physical keyboard, a mouse, etc. The communication device 518 is a device that allows the computer 14 to communicate with another device, e.g., the server 10. The communication device 518 can include one or more wireless transceivers for performing wireless communication and/or one or more communication ports for performing wired communication. The memory device 522 is a device that stores data generated or received by the computer 14. The memory device 522 can include, but is not limited to, a hard disc drive, an optical disc drive, and/or a flash memory drive.

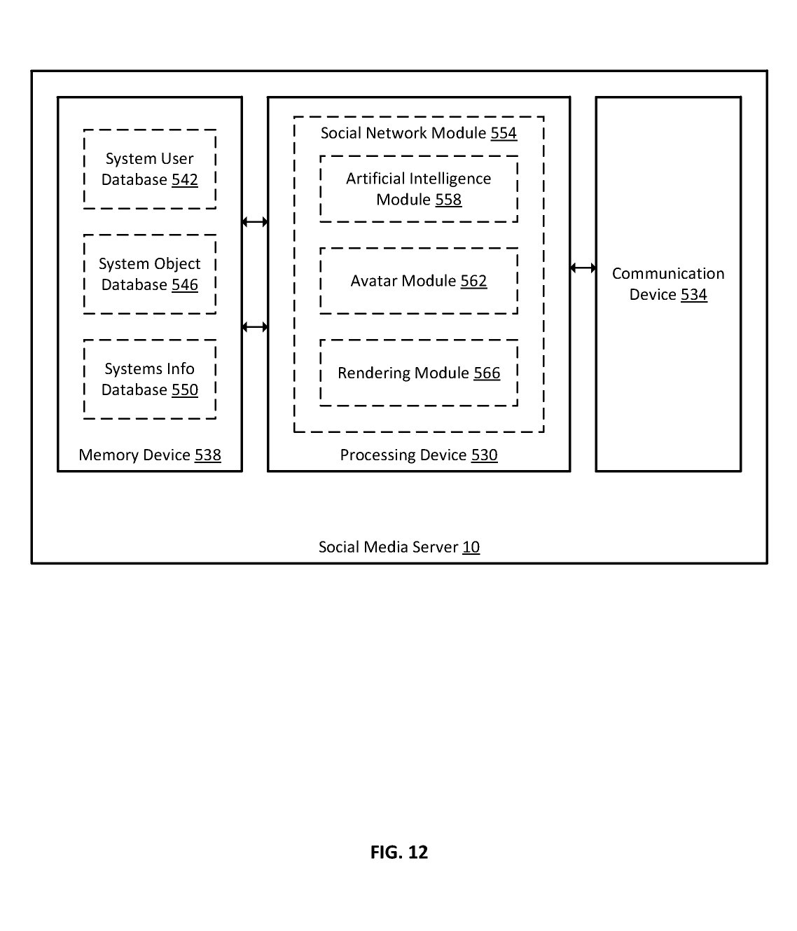

Referring now to FIG. 12, a schematic illustrating example components of a social media server 10 is shown. The server 10 may be programmed to execute some or all of the functions associated with operation of the social media network as described herein. The server 10 may include a processing device 530, a communication device 534, and a memory device 538.

The processing device 530 can include memory, e.g., read only memory (ROM) and random access memory (RAM), storing processor-executable instructions and one or more processors that execute the processor-executable instructions. In embodiments where the processing device 530 includes two or more processors, the processors can operate in a parallel or distributed manner. In the illustrative embodiment, the processing device 530 executes aspects of the social media system as discussed herein; including but not limited to curation, artificial intelligence, avatars, rendering the universe of planets and objects, etc.

The communication device 534 is a device that allows the server to communicate with another device, e.g., a computer 14, 18, etc. via the internet. The communication device 534 can include one or more wireless transceivers for performing wireless communication and/or one or more communication ports for performing wired communication.

The memory device 538 is a device that stores data generated or received by the server. The memory device 538 can include, but is not limited to a hard disc drive, an optical disc drive, and/or a flash memory drive. Further, the memory device 538 may be distributed and located across multiple disc drives. The memory device 538 is accessible to the processing device 530. Particularly, the memory device 538 stores data such as a System User database 542, a System Objects database 546, a systems information database 550, and other necessary information and databases to allow for the social media system as described herein.

The processing device 530 may execute a social network module 554 which allows the processing device 530 to operate the social network as described. More specifically, the social network module may include various sub modules such as an Artificial Intelligence module 558, an Avatar module 562, and a rendering module 566 to perform the various aspects of operating a social network as described.

The system is advantageous as it provides a social network to users which allows a user greater ability to visualize the social network and a greater ability to control information within the social network. The system provides optimally curated information to the users and continuously adapts to users within the system.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example components, dimensions, voltages, currents, frequencies, power range values, times, etc., are provided for explanation purposes and that other values may also be employed in other embodiments and examples in accordance with the teachings of the present invention.

What is claimed is:

1. A computer system comprising:
a social media server, the social media server comprising:
a computer processor;
memory connected to the computer processor for storing information associated with a social network and for providing said information to the computer processor, wherein the memory stores;
information regarding system users associated with the social network;
a social network module programmed to:
display, to an observer, a representation of a plurality of system users in a node graph wherein each system user is represented by an object in the node graph, and wherein a distance between objects in the node graph indicates strength of relationship between said objects.

2. The system of claim 1, wherein the social network module is programmed to:
display a system user as a planet when said system user is selected as a point of reference in the node graph; and
display other system users who are not selected as the point of reference differently.

3. The system of claim 2, wherein the social network module is programmed to:
display a planet which represents a system user such that the planet shows weather which is representative of current weather where said system user is physically located.

4. The system of claim 2, wherein the social network module is programmed to:
display said other system users as spheres of varying sizes to thereby represent different levels of influence for each of said other system users.

5. The system of claim 1, wherein the social network module is programmed to:
display information in a representative object whose size, location in 3-dimensional space relative to a system user, and appearance in relation to other objects are based on relevance of the information with respect to the system user.

6. The system of claim 1, wherein the social network module is programmed to:
observe actions of all system users in viewing information; and
determine what type of information is delivered to a target system user based on the actions of all system users.

7. The system of claim 6, wherein the social network module is programmed to:
determine the effect of a single system user in changing what information the system delivers to a target system user according to a relationship distance between the single system user and the target system user.

8. The system of claim 1, wherein the social network module is programmed to:
observe actions and preferences of a single system user;
embody the actions and preferences of the single system user in an avatar which represents the single system user; and
control the avatar.

9. The system of claim 8, wherein the social network module is programmed to:
provide information regarding the single system user to other system users via the avatar.

10. The system of claim 8, wherein the social network module is programmed to:
provide information regarding other system users to the single system user via the avatar.

11. A computer system comprising:
a social media server, the social media server comprising:
a computer processor;
memory connected to the computer processor for storing information associated with a social network and for providing said information to the computer processor, wherein the memory stores;
information regarding system users associated with a social network;
a social network module programmed to:
observe actions of all system users in viewing information; and
determine what type of information is delivered to a target system user based on the actions of all system users.

12. The system of claim 11, wherein the social network module is programmed to:
determine the effect of a single system user in changing what information the system delivers to a target system user according to a relationship distance between the single system user and the target system user.

13. The system of claim 11, wherein the social network module is programmed to:
observe actions and preferences of a single system user;
embody the actions and preferences of the single system user in an avatar which represents the single system user; and
control the avatar.

14. The system of claim 13, wherein the social network module is programmed to:
provide information regarding the single system user to other system users via the avatar.

15. The system of claim 13, wherein the social network module is programmed to:
provide information regarding other system users to the single system user via the avatar.

16. The system of claim 11, wherein the social network module is programmed to:
display, to an observer, a representation of a plurality of system users in a node graph wherein each system user is represented by an object in the node graph, and wherein a distance between objects in the node graph indicates strength of relationship between said objects.

17. The system of claim 16, wherein the social network module is programmed to:
display a system user as a planet when said system user is selected as the point of reference in the node graph; and
display other system users who are not selected as the point of reference in the node graph differently.

18. The system of claim 17, wherein the social network module is programmed to:
display a planet which represents a system user such that the planet shows weather which is representative of current weather where said system user is physically located.

19. The system of claim 17, wherein the social network module is programmed to:
display said other system users as spheres of varying sizes to thereby represent different levels of influence for each of said other system users.

20. The system of claim 16, wherein the social network module is programmed to:
display information in a representative object whose size, location in 3-dimensional space relative to a system user, and appearance in relation to other objects are based on relevance of the information with respect to the system user.
